(19) United States
(12) Patent Application Publication
(10) Pub. No.: US 2007/0077416 A1
(43) Pub. Date: Apr. 5, 2007

(54) Substrate for flexible wiring and method for producing the same

(75) Inventors: Toyonari Ito, Tsukuba-shi (JP); Satoshi Okamoto, Tsukuba-shi (JP)

Correspondence Address: FOLEY AND LARDNER LLP;SUITE 500, 3000 K STREET NW, WASHINGTON, DC, 20007, US

(73) Assignee: Sumitomo Chemical Company, Limited

(21) Appl. No.: 11/541,576

(22) Filed: Oct. 3, 2006

(30) Foreign Application Priority Data
Oct. 5, 2005 (JP) 2005-292479

(51) Int. Cl. B32B 15/20; B32B 15/09; B05D 5/12; B05D 3/02

(52) U.S. Cl. 428/339; 428/458; 427/372.2; 427/96.1

(57) ABSTRACT

The present invention provides a substrate for flexible wiring comprises a liquid crystalline polyester layer and a copper foil with a thickness of 5 μm or less. The substrate has a large adhesion between the resin layer and the copper foil, and is sufficient in water absorbing property and electrical properties.

### BACKGROUND OF THE INVENTION

1. Field of the Invention

The present invention relates to a substrate for flexible wiring and a method for producing the substrate.

2. Description of the Related Art

A copper-clad laminate, which is produced by forming a resin layer as an insulating resin layer on a copper foil, is known as a substrate for flexible wiring and can be used as a flexible printed wiring (hereinafter, referred to as “FPC”) after forming a wiring pattern by conducting etching or the like on the copper foil.

For example, a copper-clad laminate having ultra thin copper foil is expected as a built-in FPC in a cellular phone, a notebook computer, a portable television, and the like, which are required further downsizing.

In the copper-clad laminate having ultra thin copper foil, polyimide has been used as an insulating resin since polyimide has excellent abrasion resistance and heat resistance. A laminate of ultra thin copper foil and a polyimide layer can be manufactured by the methods such that polyimide is placed on an ultra thin copper foil with a carrier by thermocompression bonding in which the carrier is a thicker copper foil (having about 35 μm of thickness) and is placed through an adhesive layer onto the ultra thin copper foil. Alternatively, the laminate can be manufactured by the method of applying a solution containing polyamic acid, which is a polyimide precursor, onto the ultra thin copper foil with the thicker copper foil as a carrier and conducting heat treatment for drying and imidation (see, Japanese Patent Application Laid-Open (JP-A) Nos. 2003-340963 and 2004-42579).

However, such a conventional laminate of ultra thin copper foil and a polyimide layer is insufficient as a substrate for flexible wiring in the case of forming minute wiring pattern, particularly for fine pitch formation such as multi pins and the narrow pitch. For example, polyimide is easy to absorb moisture, and therefore, bubbles, voids (vacancies), creases and the like tend to be generated between the copper foil and the polyimide layer in the laminate in the production process of the laminate, which results in causing difficulty in forming minute wiring pattern.

Further, the polyimide layer is insufficient in electrical property. For example, dissipation factor of the polyimide layer is relatively large, which may cause loss of an electric signal flowing in wiring due to heat loss. In addition, electrical property of the polyimide layer is unstable since the polyimide layer is easy to absorb moisture with time.

### SUMMARY OF THE INVENTION

One of the objects of the present invention is to provide a copper-foil laminate, which can be used as a substrate for flexible printed wiring, with low water absorption property and good electrical property (for example, small dissipation factor) of the resin layer therein.

The present inventors have zealously investigated and consequently found a substrate with such properties.

The present invention provides a substrate for flexible wiring comprises a liquid crystalline polyester layer and a copper foil with a thickness of 5 μm or less.

Such a substrate is sufficient in water absorption property and electrical property.

The substrate of the present invention may be produced by applying a liquid crystalline polyester solution on an ultra thin copper foil with a carrier, conducting first heating process to remove the solvent in the applying liquid and the second heating process to orientate the liquid crystalline polyester. Thus obtained substrate has substantially no crease and the like in the ultra thin copper foil.

Because liquid crystalline polyester is low in water absorption property compared to polyimide, the generation of voids and the like in the resin layer can be prevented enough in production process of the substrate, and processing with sufficient accuracy is possible even in the case of forming a minute wiring pattern. In addition, the substrate for flexible printed wiring of the present invention has good electrical property.

Moreover, the substrate for flexible printed wiring of the present invention has ultra thin copper foil of 5 μm or less in thickness, and a flexible printed wiring in which a minute wiring pattern has been formed can be produced easily.

### BRIEF DESCRIPTION OF THE DRAWINGS

FIG. 1 is a schematic fragmentary sectional view showing one embodiment of the substrate for flexible printed wiring of the present invention.

FIG. 2 is a schematic fragmentary sectional view showing the aspect of the ultra thin copper foil in the state of being fixed on the support.

FIG. 3 is a sectional view of the process in the producing method of the substrate for flexible printed wiring of the present invention.

FIG. 4 is a schematic fragmentary sectional view showing another embodiment of the substrate for flexible printed wiring of the present invention.

### DETAILED DESCRIPTION OF THE PREFERRED EMBODIMENTS

A substrate for flexible wiring in the present invention comprises a liquid crystalline polyester layer and a copper foil with a thickness of 5 μn or less.

The substrate for flexible printed wiring preferably has 7 N/cm or more of peel strength at an angle of 180° between the resin layer and the ultra thin copper foil is at 23° C. Here, peel strength at an angle of 180° between the resin layer and the ultra thin copper foil means a strength needed for peeling the copper foil off the resin layer when the copper foil is pulled in the horizontal direction to the resin layer. Such a substrate having the strength of 7 N/cm or more shows a good adhesion between the ultra thin copper foil and the resin layer. When such a substrate is used, defects such as peeling between the copper foil and the resin layer are not caused easily in, for example, forming a wiring pattern on the substrate, thereby providing high reliability of the resulting flexible printed wiring when processed and utilized in various applications.

The substrate for flexible printed wiring in the present invention may show folding endurance of 100 or more. Here, the folding endurance is expressed by the number of times when wiring is disconnected in a repeating, folding test according to JIS C6471 (1995) (curvature radius of folding surface of 0.38 mm; and tension of 4.9 N in). Recently, the numbers of folding parts in the flexible printed wiring increases, and the angle made by the two surfaces forming the folding parts has become small, along with high density mounting of electronic parts in an electronic device. For this reason, when a substrate with less than 100 times of folding endurance is utilized, wiring may be easily disconnected in ductility fatigue of ultra thin copper foil, and the electric reliability tends to decrease.

A liquid crystalline polyester used in the present invention may have a structural unit(s) of —Ar¹—, —Ar²— and/or —Ar³— are connected by —COO— (or —OCO—) and —CONH— (or —NHCO—). The liquid crystalline polyester preferably has the structural units represented by formulas (i), (ii) and (iii) below, and the amounts of the structural units represented by the formula (i), (ii) and (iii) are 30 to 80% by mole, 10 to 35% by mole and 10 to 35% by mole on the basis of the total structural units in the polyester, respectively;
—O—Ar¹—CO— (i)
—CO—Ar²—CO— (ii)
—X—Ar³—Y— (iii)
where Ar¹ indicates phenylene, naphtylene or biphenylene, Ar² indicates that phenylene, naphthylene, biphenylene, oxybiphenylene or a bivalent condensed aromatic ring, Ar³ indicates phenylene or a bivalent condensed aromatic ring, X and Y are the same or different, each independently indicating —O— or —NH—. The hydrogen atom(s) bonded the aromatic ring of Ar¹, Ar² and Ar³ may be substituted by a halogen atom, an alkyl group or an aryl group.

The liquid crystalline polyester preferably has the structural unit derived from aromatic diamine and/or the structural unit derived from aromatic amine having a hydroxyl group in the amount of 10 to 35% by mole on the basis of the total structural units. This means that the liquid crystalline polyester preferably has the structural unit represented by formula (iii) with —NH— as X and/or Y in the amount of 10 to 35% by mole on the basis of the total structural units.

The above-mentioned liquid crystalline polyester has high solubility in a solvent. A liquid crystalline polyester solution can be easily prepared by dissolving the liquid crystalline polyester in a solvent. A layer of the liquid crystalline polyester can be formed easily by applying a solution containing the liquid crystalline polyester and a solvent on a prescribed place (of copper foil or the like), and removing the solvent.

The resin layer containing liquid crystalline polyester has low water absorption, good electrical properties and practically sufficient adhesive properties with adjacent layer such as an ultra thin copper foil.

The substrate for flexible printed wiring can be produced by a method in which, for example, a solution containing liquid crystalline polyester and a solvent is applied on a ultra thin copper foil having a thickness of 5 μm or less with a support (a carrier), the solvent is removed, and then the support is removed.

When the ultra thin copper foil is fixed on a support (a carrier), the ultra thin copper foil is easily handled in forming a resin layer onto the ultra thin copper foil. After the resin layer is formed, the support can be removed to give a substrate for flexible printed wiring.

The support is preferably made from a metal. This is because it is preferred for the support to have about the same thermal expansion coefficient as that of the ultra thin copper foil.

The ultra thin copper foil is preferably fixed on a support through a thermal diffusion prevention layer (that is a layer preventing ions in ultra thin copper foil from diffusing to the adjacent layer by heating). When a thermal diffusion prevention layer exists between the ultra thin copper foil and the support, the shift of copper ions (Cu²⁺) which can be generated when being heated is controlled enough in forming a resin layer on the ultra thin copper foil. Therefore, an excessive bonding of the ultra thin copper foil and the support by the shift of copper ions can be prevented, and consequently the ultra thin copper foil can be easily separated from the support to give the substrate for flexible printed wiring.

According to the present invention, a substrate for flexible printed wiring that can achieve both of decreasing the water absorbing property of the resin layer and the electrical property of the resin layer in a high level by the use of a resin material taking the place of polyimide, and the method for producing the substrate are provided. The substrate for flexible printed wiring is not only excellent in flexibility, but when a wiring pattern is formed on the copper foil using an etching liquid, the flexible printed wiring can be simply obtained because the resin layer is not deteriorated by the etching liquid.

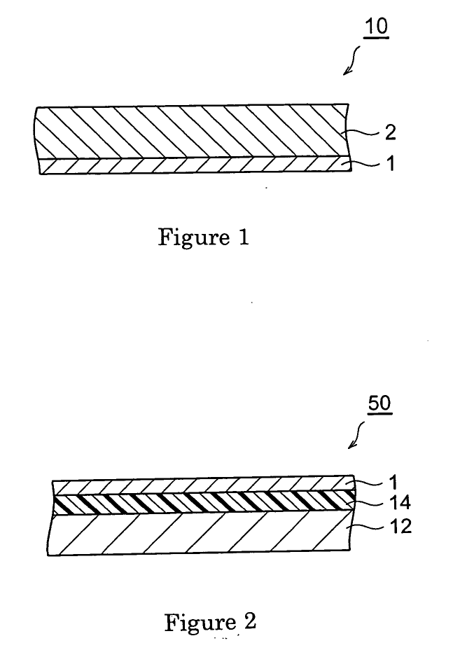

Hereinafter, one of embodiments of the present invention will be described in detail. FIG. 1 is a schematic fragmentary sectional view showing one embodiment of the substrate for flexible printed wiring of the present invention. In substrate (substrate for flexible printed wiring) 10 shown in FIG. 1, liquid crystalline polyester layer (resin layer) 2 containing the liquid crystalline polyester is formed on the surface of one side of ultra thin copper foil 1 of 5 μm or less in thickness.

<Ultra Thin Copper Foil>

First, ultra thin copper foil 1 will be described. FIG. 2 is a schematic fragmentary sectional view showing the aspect of ultra thin copper foil 1 in the state of being fixed on carrier layer (support) 12. In ultra thin copper foil 50 with a carrier shown in FIG. 2, ultra thin copper foil 1 is fixed on carrier layer 12 through adhesive layer (thermal diffusion prevention layer) 14.

The thickness of ultra thin copper foil 1 is 5 μm or less. The lower limit of the thickness of ultra thin copper foil 1 is preferably 1 μm from a practical standpoint. The ultra thin copper foil 1 of 5 μm or less in thickness is preferably used in the state of being fixed on carrier layer 12 because creases easily enter and consequently handling the foil alone is difficult. The ultra thin copper foil that has been subjected to the surface treatment may be used as ultra thin copper foil 1. Examples of the surface treatments include surface roughening treatment, heat discoloring prevention treatment, and rust prevention treatment. The surface roughness of ultra thin copper foil 1 is preferably 0.5 to 2.0 μm from the viewpoint of assuring the anchoring property of liquid crystalline polyester layer 2.

Any one consisting of a material that can hold ultra thin copper foil 1 can be used as carrier layer 12. The material of carrier layer 12 is preferably made of metal. Carrier layer 12 is more preferably made from copper layer as in ultra thin copper foil 1 from the viewpoint of the thermal expansion coefficient. When copper foil is used as carrier layer 12, the thickness of the copper foil is preferably 12 to 70 μm from a practical standpoint. A rolled annealed copper foil and an electrodeposited copper foil can be used as the copper foil having the thickness within the range.

An organic adhesive or an inorganic adhesive can be used in adhesive layer 14. Adhesive layer 14 preferably comprises an inorganic adhesive from the viewpoints of holding adhesive properties in heating and controlling the generation of gas. Examples of the inorganic adhesive include an adhesive containing silica or mica as its main component and water as a dispersion medium.

Adhesive layer 14 plays a role as the thermal diffusion prevention layer of copper ions which prevent bonding of ultra thin copper foil 1 and carrier layer 12 by the shift of copper ions (Cu²⁺). In producing a substrate for flexible printed wiring, when ultra thin copper foil 1 is heated in the state of being fixed on carrier layer 12, shifting of copper ions from ultra thin copper foil 1 to carrier layer 12 is controlled enough by adhesive layer 14 inserted between them. When carrier layer 12 is comprised of copper foil, it is controlled enough that copper ions shift between ultra thin copper foil 1 and carrier layer 12 mutually. Because of existing of adhesive layer 14, an excessive bonding of ultra thin copper foil 1 and carrier layer 12 by the shift of copper ions can be prevented, and ultra thin copper foil 1 can be separated easily from carrier layer 12 in the process where the substrate for flexible printed wiring is finally obtained.

<Liquid Crystalline Polyester Layer>

Next, liquid crystalline polyester layer (resin layer) 2 will be described. Liquid crystalline polyester contained in liquid crystalline polyester layer 2 is polyester that is referred to as a thermotropic liquid crystalline polymer, which forms a melt showing optically anisotropy at a temperature of 450° C. or lower. The liquid crystalline polyester is preferable to contain structural units shown by the following formulas (i), (ii), and (iii) as the structural units, and to be that the structural unit shown by the formula (i) is 30 to 80% by mole, the structural unit shown by formula (ii) is 10 to 35% by mole, and the structural unit shown by formula (iii) is 10 to 35% by mole.
—O—Ar¹—CO— (i)
—CO—Ar²—CO— (ii)
—X—Ar³—Y— (iii)
here in the above-mentioned formulas, Ar¹ indicates phenylene, naphtylene, or biphenylene, Ar² indicates phenylene, naphthylene, biphenylene, oxybiphenylene or a bivalent condensed aromatic group, Ar³indicates phenylene or a bivalent condensed aromatic group, and X and Y are the same or different, and indicate O or NH. Moreover, a halogen atom, an alkyl group, or an aryl group may be substituted for the hydrogen atom bonded to an aromatic ring of Ar¹, Ar², or Ar³.

Specifically, liquid crystalline polyesters include
(1) those obtained by polymerizing an aromatic hydroxycarboxylic acid, an aromatic dicarboxylic acid, and an aromatic diol,
(2) those obtained by polymerizing the same kinds or different kinds of aromatic hydroxycarboxylic acids,
(3) those obtained by polymerizing an aromatic dicarboxylic acid and an aromatic diol,
(4) those obtained by polymerizing an aromatic hydroxycarboxylic acid, an aromatic dicarboxylic acid, and an aromatic diol, and also an aromatic amine and/or an aromatic diamine having a phenolic hydroxyl group,
(5) those obtained by polymerizing an aromatic hydroxycarboxylic acid, an aromatic dicarboxylic acid, and an aromatic amine having a phenolic hydroxyl group,
(6) those obtained by polymerizing an aromatic dicarboxylic acid, and an aromatic amine having a phenolic hydroxyl group,
(7) those obtained by polymerizing an aromatic hydroxycarboxylic acid, an aromatic dicarboxylic acid, and an aromatic diamine, and
(8) those obtained by polymerizing an aromatic dicarboxylic acid, and an aromatic diamine (however, polymers containing a liquid crystallineline polyester part in the molecule).

Liquid crystalline polyester contained in liquid crystalline polyester layer 2 is preferable to have the structural unit derived from aromatic diamine and/or the structural unit derived from aromatic amine having a phenolic hydroxyl group in the rate of 10 to 35% by mole to the total structural units.

Such liquid crystalline polyester compounds include those of the above-mentioned (5), (6), (7), and (8). And it is preferable to use liquid crystalline polyester selected from these compounds, because the use of these liquid crystalline polyester compounds makes it possible to obtain a resin layer excellent in heat resistance and dimensional stability.

In place of the above-mentioned an aromatic hydroxycarboxylic acid, an aromatic dicarboxylic acid, an aromatic diol, and an aromatic amine having a phenolic hydroxyl group, these ester forming derivatives or amide forming derivatives may be used.

Ester forming derivatives or amide forming derivatives of a carboxylic acid include derivatives that accelerate polyester formation reaction or polyamide formation reaction, for example, derivatives such as acid chlorides and acid anhydrides of which reaction activity is improved, and ester or amide derivatives (those formed by reacting a carboxylic group with alcohols, ethylene glycol, amine, and the like) that polyester or polyamide can be formed by transesterification or transamidation.

Ester forming derivatives of a phenolic hydroxyl group include, for example, those that the phenolic hydroxyl groups form esters with carboxylic acids similarly to forming polyester by transesterification.

Amide forming derivatives of an amino group include, for example, those that the amino groups form amides with carboxylic acids similarly to forming polyamide by transamidation.

Moreover, an aromatic hydroxycarboxylic acid, an aromatic dicarboxylic acid, an aromatic diol, and an aromatic amine and an aromatic diamine having a phenolic hydroxyl group may be substituted with halogen atoms such as a chlorine atom and a fluorine atom, alkyl groups such as a methyl group and an ethyl group, aryl groups such as a phenyl group, and the like in the extent unless the ester formation or the amide formation is not obstructed.

As the repeated structural units in liquid crystalline polyester used in the present invention, though the following structural units can be exemplified, the repeated structural units are not limited to them.

The structural units (structural units derived from aromatic hydroxylic acid) shown by the formula (i) include those shown by the following chemical formula (A¹) to (A⁵). Moreover, a halogen atom, an alkyl group, or an aryl group may be substituted for the hydrogen atom bonded to an aromatic ring in the following structural units.

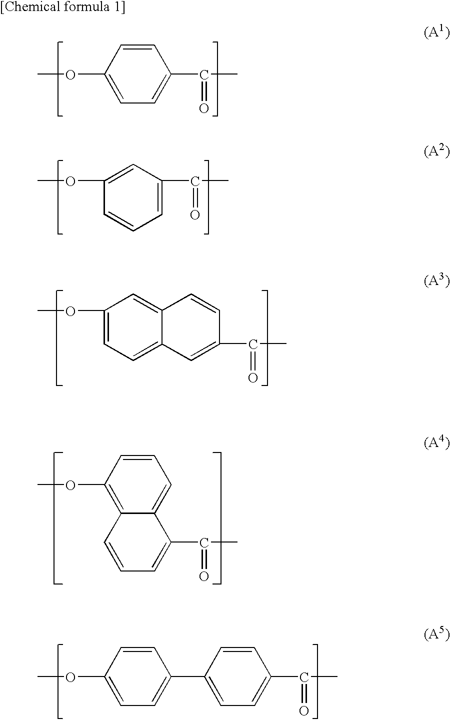

To the total structural units, the structural unit (i) is preferable to be 30 to 80% by mole, more preferable to be 40 to 70% by mole, and further preferable to be 45 to 65% by mole. When the structural unit (i) is over 80% by mole, the solubility tends to decrease remarkably, and when being less than 30% by mole, the liquid crystallinity tends to benotshown. lo The structural units (structural units derived from aromatic dicarboxylic acid) shown by the formula (ii) include those shown by the following chemical formula (B¹) to (B⁸). Moreover, a halogen atom, an alkyl group, or an aryl group may be substituted for the hydrogen atom bonded to an aromatic ring in the following structural units.

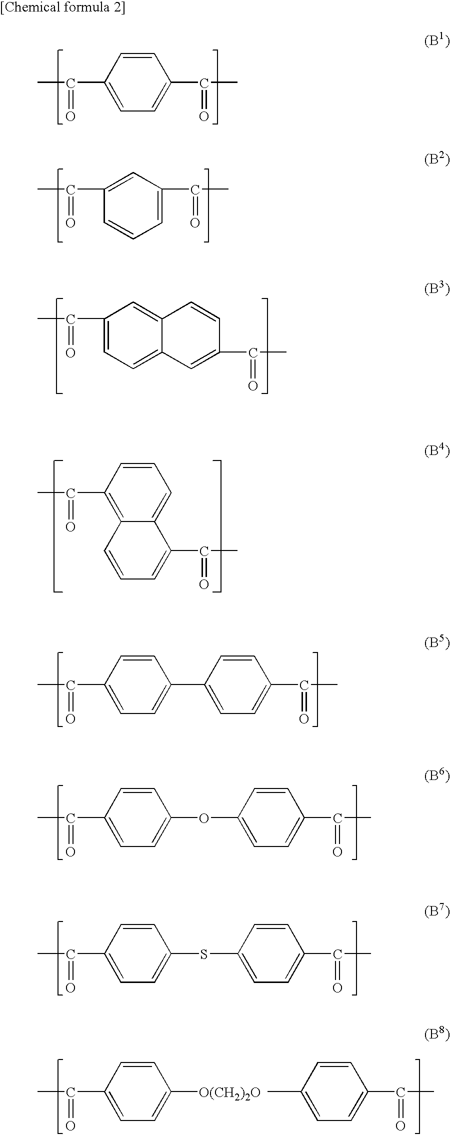

To the total structural units, the structural unit (ii) is preferable to be 35 to 10% by mole, more preferable to be 30 to 15% by mole, and further preferable to be 27.5 to 17.5% by mole. When the structural unit (ii) is over 35% by mole, the liquid crystallinity tends to lower, and when being less than 10% by mole, the solubility tends to lower.

The structural units shown by the formula (iii) include the structural units derived from aromatic diols, the structural units derived from aromatic amines having a phenolic hydroxyl group, and the structural units derived from aromatic diamines.

The structural units derived from aromatic diols include those shown by the following chemical formula (C¹) to (C¹⁰). Moreover, a halogen atom, an alkyl group, or an aryl group may be substituted for the hydrogen atom bonded to an aromatic ring in the following structural units.

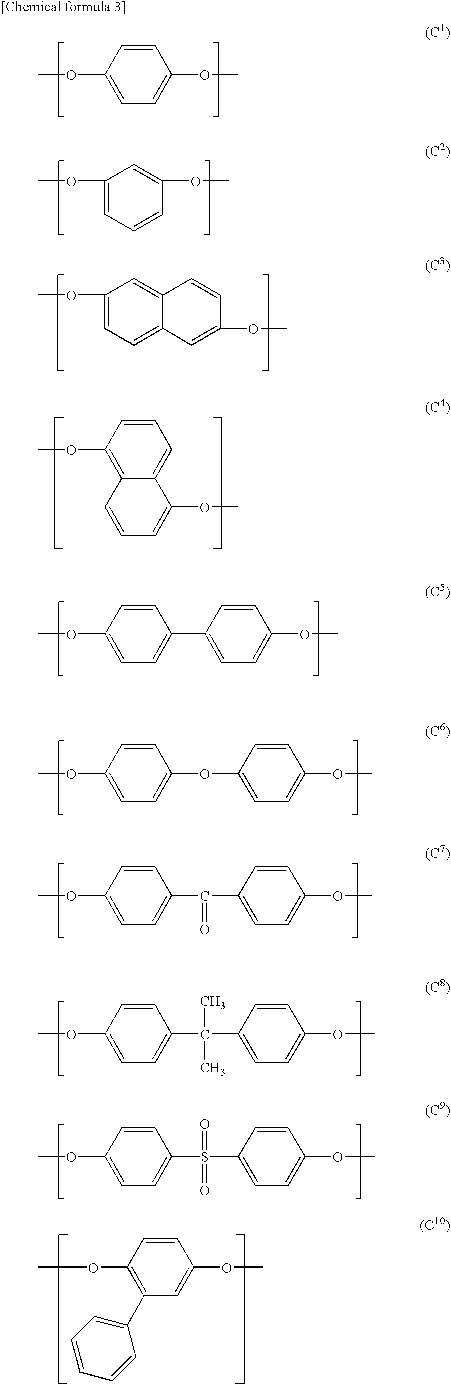

The structural units derived from aromatic amines having a phenolic hydroxyl group include those shown by the following chemical formula (D¹) to (D⁶). Moreover, a halogen atom, an alkyl group, or an aryl group may be substituted for the hydrogen atom bonded to an aromatic ring in the following structural units.

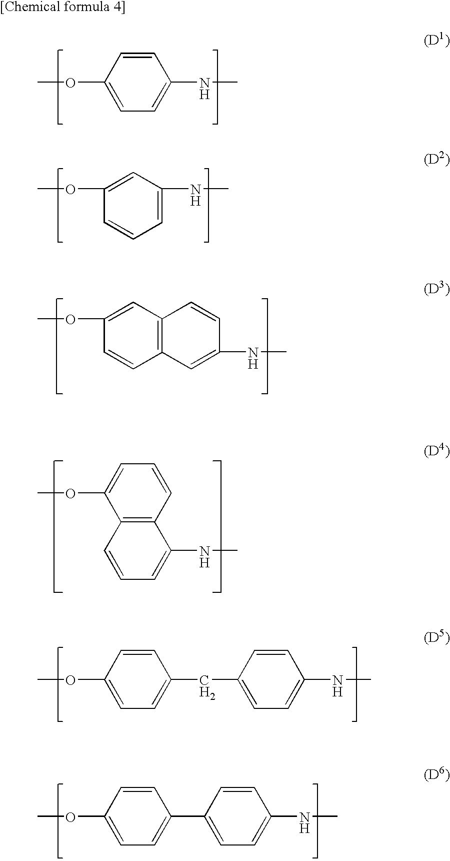

The structural units derived from aromatic diamines include those shown by the following chemical formula (E¹) to (E⁶). Moreover, a halogen atom, an alkyl group, or an aryl group may be substituted for the hydrogen atom bonded to an aromatic ring in the following structural units.

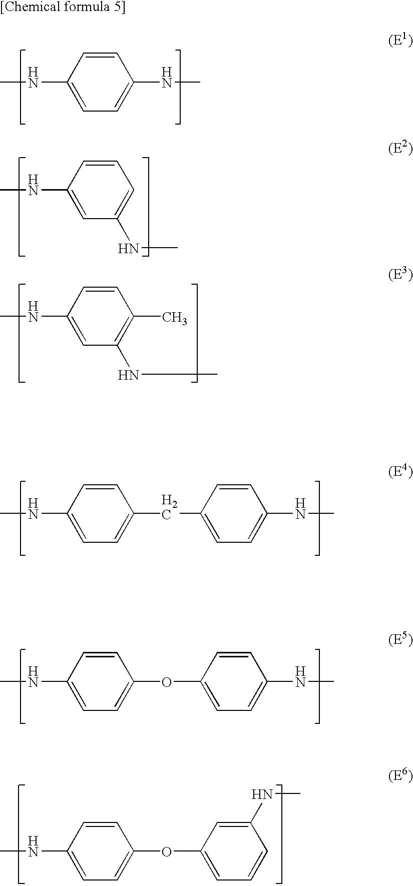

As alkyl groups that may be substituted in the above-mentioned structural units, for example, alkyl groups having carbon number of 1 to 10 are usually used, and among them, the methyl group, the ethyl group, the propyl group, and the butyl group are preferable. As aryl groups that may be substituted in the structural units, aryl groups having carbon number of 6 to 20 are usually used, and among them, the phenyl group is preferable.

To the total structural units, the structural unit (iii) is preferable to be 35 to 10% by mole, more preferable to be 30 to 15% by mole, and further preferable to be 27.5 to 17.5% by mole. When the structural unit (iii) is over 35% by mole, the liquid crystallinity tends to lower, and when being less than 10% by mole, the solubility tends to lower.

In order to achieve both of the heat resistance and dimensional stability of liquid crystalline polyester layer in a high level, the liquid crystalline polyester is preferable to contain the structural units shown by the above-mentioned (A¹), (A³), (B¹), (B²), or (B³). The preferable combinations of these structural units include the following (a) to (e).
(a): the combination of structural units of (A¹), (B²), and (D¹), the combination of structural units of (A³), (B²), and (D¹), the combination of structural units of (A¹), (B¹), and (D¹), the combination of structural units of (A³), (B³), and (D¹), or the combination of structural units (B¹), (B²) or (B³), and (D¹).
(b): the combinations that a part or all of (D¹) was replaced with (D²) in each of the above-mentioned combinations of (a).
(c): the combinations that a part or all of (A¹) was replaced with (A³) in each of the above-mentioned combinations of (a).
(d): the combinations that a part or all of (D¹) was replaced with (E¹) or (E⁵) in each of the above-mentioned combinations of (a).
(e): the combinations that a part (D¹) was replaced with (C¹) or (C²) in each of the above-mentioned combinations of (a).

The further preferable combination of the structural units include the combination comprised of 30 to 80% by mole of the structural unit derived from at least one kind of compound selected from the group consisting of p-hydroxybenzoic acid and 2-hydroxy-6-naphthoic acid, 10 to 35% by mole of the structural unit derived from at least one kind of compound selected from the group consisting of 4-hydroxyaniline and 4,4′-diaminodiphenyl ether, and 10 to 35% by mole of the structural unit derived from at least one kind of compound selected from the group consisting of terephthalic acid and isophthalic acid. And the particularly preferable combination includes that comprised of 30 to 80% by mole of the structural unit derived from 2-hydroxy-6-naphthoic acid, 10 to 35% by mole of the structural unit derived from 4-hydroxyaniline, and 10 to 35% mole of the structural unit derived from isophthalic acid.

Though the method for producing the liquid crystalline polyester used in the present invention is not especially limited, the method includes, for example, the following method: a phenolic hydroxyl group or an amino group of an aromatic hydroxy acid corresponding to the structural unit (i), and aromatic amine and aromatic diamine having a hydroxyl group corresponding to the structural unit (iii) is acylated with an excessive amount of fatty acid anhydride to give an acyl compound, and the transesterification (polycondensation) of the obtained acyl compound and an aromatic dicarboxylic acid corresponding to the structural unit (ii) is conducted and then the melt polymerization is conducted.

In the acylation reaction, the amount of fatty acid anhydride added is preferable to be 1.0 to 1.2 times the equivalent weight of the total amount of a phenolic hydroxyl group and an amino group, more preferable to be 1.05 to 1.1 times the equivalent weight. When the amount of fatty acid anhydride added is less than 1.0 times the equivalent weight, the acyl compound, the aromatic hydroxycarboxylic acid, the aromatic dicarboxylic acid, and the like sublimate at the time of the polycondensation by the transesterification and transamidation, and the reaction system tends to be easily blocked up. And when the amount is over 1.2 times the equivalent weight, the coloration of the obtained liquid crystalline polyester tends to be remarkable.

The acylation reaction is preferable to be carried out at 130 to 180° C. for five minutes to ten hours, and more preferable to be carried out at 140 to 160° C. for ten minutes to three hours.

Fatty acid anhydrides used in the acylation reaction are not especially limited and include, for example, acetic anhydride, propionic anhydride, butylic anhydride, isobutylic anhydride, valeric anhydride, pivalic anhydride, 2-ethyl hexanoic anhydride, monochloroacetic anhydride, dichloroacetic anhydride, trichloroacetic anhydride, monobromoacetic anhydride, dibromoacetic anhydride, tribromoacetic anhydride, monofluoroacetic anhydride, difluoroacetic anhydride, trifluoroacetic anhydride, glutaric anhydride, maleic anhydride, succinic anhydride, and β-bromopropionic anhydride, and these may be used as the mixture of two kinds or more. Acetic anhydride, propionic anhydride, s butylic anhydride, and isobutylic anhydride are preferable from the viewpoints of the cost and handle-ability, and acetic anhydride is more preferable.

In the polymerization by the transesterification and the transamidation, the acyl group of the acyl compound is preferable to be 0.8 to 1.2 times the equivalent weight of carboxyl group.

The polymerization by the transesterification and the transamidation is preferably carried out at 130 to 400° C. while the temperature is raised at the rate of 0.1 to 50° C./minute, and more preferably carried out at 150 to 350° C. while the temperature is raised at the rate of 0.3 to 5° C./minute. Moreover, at this time, the fatty acid generated as a by-product and unreacted fatty acid anhydride are preferably distilled and removed outside by being vaporized in order to move the equilibrium.

Further, the acylation reaction and the polymerization by the transesterification and the transamidation may be carried out in the presence of a catalyst. As the catalysts, those conventionally known as the catalyst for the polymerization of polyester can be used, and such catalysts include, for example, metal salt catalysts such as magnesium acetate, stannous acetate, tetrabutyl titanate, lead acetate, sodium acetate, potassium acetate, and antimony trioxide, and organic compound catalysts such as N,N-dimethylaminopyridine and N-methylimidazole. The catalyst is usually made to exist at the time of the acylation reaction, and does not necessarily need to be removed after the acylation. When the catalyst is not removed, the next processing can be conducted as it is. When the next processing is carried out, the catalyst as mentioned above may be further added.

Although the polymerization by the transesterification and the transamidation can be conducted only in the melt polymerization, the melt polymerization and the solid-state polymerization may be used together. As for the solid-state polymerization, after polymers are pulled out from the melt polymerization process and solidified, the polymers are crushed to make powder-like or flake-like polymers, and then the solid-state polymerization of the crushed polymer can be conducted by the well-known method. Specifically, for example, such a method can be cited that the heat treatment of the crushed polymer is conducted at the solid-state under the inert atmosphere such as nitrogen at 20 to 350° C. for 1 to 30 hours. The solid-state polymerization may be conducted while the crushed polymer is stirred, or may be conducted at the state of leaving the crushed polymer at rest without stirring. In addition, the melt polymerization tank and the solid-state polymerization tank can also be made the same reactive tank by installing a suitable stir mechanism. After the solid-state polymerization, the obtained liquid crystalline polyester may be pelletized by the well-known method and used.

The manufacture of liquid crystalline polyester can be conducted using, for example, a batch apparatus, a continuous apparatus, and the like. The weight average molecular weight of liquid crystalline polyester is usually about 100,000 to 500,000.

As for the liquid crystalline polyester produced as mentioned above, the value of the dissipation factor in the high-frequency band (1-100 GHz) is preferable to be small, and specifically the value of the dielectric dissipation factor is preferable to be 0.005 or less. When the value of the dissipation factor is over 0.005, an electric signal flowing in wiring tends to become heat to be lost and to attenuate.

Moreover, the water absorbing property of liquid crystalline polyester is preferable to be low. The water absorption coefficient of liquid crystalline polyester (after being left for 24 hours in the conditions that temperature is 23° C. and humidity is 50%) is preferable to be 1.0% by mass or less, and more preferable to be 0.3% by mass or less. When the water absorption coefficient is over 1.0% by mass, there is a tendency that voids and the like are generated in liquid crystalline polyester layer 2 in the producing process of a flexible printed wiring. Here, water absorption coefficient is the value obtained by dividing the amount of an increase in the mass of a sample to be measured by water absorption treatment by the mass of the sample before the water absorption treatment. In addition, the water absorption treatment is to leave a sample to be measured to stand for 24 hours in the conditions that temperature is 23° C. and humidity is 50%, and as the sample to be measured, a sample that has been left to stand in a constant-temperature bath kept at a temperature of 50±2° C. for 24 hours as pretreatment is used. In the case of using the liquid crystalline polyester with the above-mentioned structural unit represented by formula (iii), it is preferred in the formula (iii) that either one of X and Y is —O— and the other one is —NH—, in view of solubility in a solvent and water absorbing property of liquid crystalline polyester.

Though resin layer 2 containing liquid crystalline polyester is comprised of the liquid crystalline polyester produced as mentioned above, in addition to the liquid crystalline polyester, an inorganic filler may be contained. When liquid crystalline polyester layer 2 contains an inorganic filler, it is possible to improve more the mechanical characteristics such as strength, elastic modulus, and dimensional accuracy, and electrical properties such as electrical insulation and dielectric characteristic of the liquid crystalline polyester layer 2.

Usable inorganic fillers include aluminum borate, potassium titanate, magnesium sulfate, zinc oxide, silicon carbide, silicon nitride, glass fiber, and alumina fiber.

When the resin layer 2 containing liquid crystalline polyester contains an inorganic filler, the rate of content is preferable to be 5 to 30 parts by volume on the assumption that the liquid crystalline polyester contained in the resin layer 2 is 100 parts by volume, and more preferable to be 10 to 20 parts by volume. When the rate of content of an inorganic filler is less than 5 parts by volume, the effect of the addition of the inorganic filler tends not to be obtained enough, and when being over 30 parts by volume, the folding endurance of the substrate for flexible printed wiring tends to become insufficient.

The thickness of the resin layer 2 containing liquid crystalline polyester is preferable to be 0.5 to 500 μm from the viewpoints of the film forming property and mechanical characteristics, and more preferable to be 1 to 100 μm from the viewpoint of the handle-ability.

<The Method for Producing a Substrate for Flexible Printed Wiring>

Hereinafter, the method for producing a substrate for flexible printed wiring will be described. The substrate for flexible printed wiring of the present invention can be obtained by forming a resin layer containing liquid crystalline polyester on an ultra thin copper foil or on the side applied with no carrier layer of an ultra thin copper foil on which a carrier layer has been applied. Here, because the adhesive property between the resin layer and the copper foil is preferable to be higher as described later, the surface treatment on the copper foil may be performed before forming the resin layer. As the surface treatment, generally an adhesion improver such as a silane coupling agent is used. That is, the silane coupling agent solution prepared to be about 0.1 to 10% by weight in concentration is applied on the side of the copper foil on which side a resin layer is to be formed, and the solvent contained in the silane coupling agent solution is removed by the use of ventilation or the heat treatment at about 50 to 100° C. and thus the surface treatment of the copper foil is performed. Though solvents for such a silane coupling agent solution are not limited as long as they are in the range where the silane coupling agent to be used is not deactivated and the surface of the copper foil is not injured, alcohol solvents such as methanol, ethanol, and n-butanol, ketones such as acetone and methyl isobutyl ketone, esters such as propyl acetate and butyl acetate, aromatic hydrocarbons such as toluene and xylene, or mixed solvents of them are used from the viewpoint of easily removable after being applied.

As a silane coupling agent, those easily available from the market can be used. For example, the compounds shown by the following (F₁) to (F₇) can be enumerated. Though these silane coupling agents might be partly made to be oligomers by moisture in air, as the above-mentioned adhesin improver, oligomerized by-products may be removed or may be not removed.

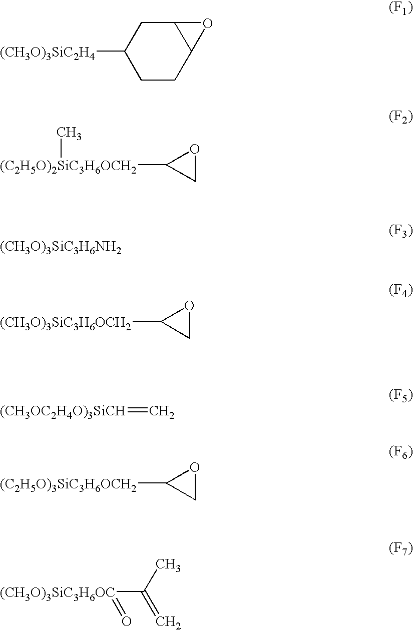

The methods for forming the above-mentioned resin layer include the method in which liquid crystalline polyester is heated and melted and then extruded and molded on the surface of the copper foil, or the method in which using an applying solution obtained by dissolving liquid crystalline polyester in a suitable solvent, the applying solution is cast and applied on the surface of the copper foil to form a resin layer. Among such methods, the latter method is particularly preferable because the operation is simple and the resin layer of uniform film thickness can be obtained easily. Moreover, the above-mentioned adhesion improver for improving the adhesion property of the resin layer and the copper foil can also be added in the applying liquid.

As liquid crystalline polyester that is applied to the present invention, the liquid crystalline polyester containing the structural unit derived from aromatic diamine and/or the structural unit derived from aromatic amine having a hydroxyl group in the rate of 10 to 35% by mole to the total structural units can be preferably used because the adhesive property of the resin layer and the copper foil can be improved even if the surface treatment of the copper foil with an adhesion improver is not performed or an adhesion improver is not added in the applying solution containing the liquid crystalline polyester.

Next, the method for preparing an applying solution for the resin layer containing liquid crystalline polyester will be described.

The applying solution can be obtained by dissolving liquid crystalline polyester in a solvent. The solvents are not especially limited as long as they dissolve liquid crystalline polyester, and include, for example, N,N′-dimethylacetamide, N-methyl-2-pyrrolidone, N-methyl caprolactam, N,N′-dimethylformamide, N,N′-diethylformamide, N,N′-diethylacetamide, N-methyl propionamide, dimethyl sulfoxide, y-butyrolactone, dimethylimidazolidinone, tetramethylphosphoric amide, and ethylcellosolve acetate, besides halogenated phenols such as parafluorophenol, parachlorophenol, and perfluorophenol. These solvents can be used alone or in mixture.

Though the amount of a solvent used can be suitably selected according to the use, liquid crystalline polyester is preferable to be 0.5 to 50 parts by mass to 100 parts by mass of the solvent, and more preferable to be 10 to 20 parts by mass. When liquid crystalline polyester is less than 0.5 parts by mass, there is a tendency that the solution cannot be applied uniformly because the viscosity of the solution is too low, when being over 50 parts by mass, the viscosity of the solution tends to become high.

Further, though the solution that liquid crystalline polyester has been dissolved in the above-mentioned solvent may be used as an applying solution, the solution is preferable to be made to pass through a filter and the like to remove minute foreign matter contained in the solution.

Moreover, when liquid crystalline polyester layer 2 containing an inorganic filler is formed, the one that the prescribed amount of an inorganic filler is added in the solution, which has dissolved liquid crystalline polyester, has only to be made an applying solution. In this case, the amount of the inorganic filler added has only to be adjusted so that the content of the inorganic filler in the liquid crystalline polyester layer 2 after the removal of the solvent will be the desired amount.

When a resin layer is thus formed using an applying solution containing liquid crystalline polyester, the thickness of the resin layer can be adjusted by the applying times of the applying solution or the viscosity of the applying solution at the time of forming the resin layer.

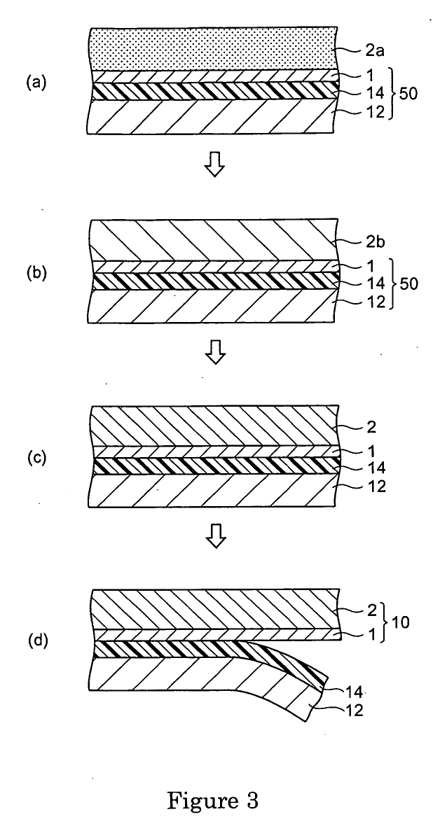

In the next place, the method for producing substrate 10 by the use of the applying solution prepared as mentioned above will be described with reference to FIG. 3.

FIG. 3A is a schematic sectional view showing the state that an applying liquid containing solution crystalline polyester is applied on the surface of ultra thin copper foil 1 and film 2a is formed. The methods of applying the applying solution include, for example, various kinds of means such as the roller coating method, the dipcoating method, the spray coating method, the spinner coating method, the curtain coating method, the slot coating method, and the screen printing method. Using these means, the applying liquid is cast evenly and uniformly and film 2a is formed.

FIG. 3B is a schematic sectional view showing the state that the solvent in film 2a is removed and liquid crystalline polyester layer 2b in non-orientated state is formed on the surface of ultra thin copper foil 1. The method of removing the solvent is preferably carried out by the evaporation of the solvent. Though the methods for evaporating the solvent include heating, depressurizing, and ventilation, among them, it is preferable to heat and vaporize the solvent in terms of production efficiency and handling, and it is more preferable to heat and vaporize the solvent while ventilation is used. In case of removing the solvent by heating, the film 2a only has be held at temperatures of 80 to 200° C. for 10 to 120 minutes.

FIG. 3C is a schematic sectional view showing the state that the molecules of liquid crystalline polyester in non-orientated state are orientated by being heated and liquid crystalline polyester layer 2 is formed. When the molecules of liquid crystalline polyester are orientated, the molecules only have to be held at temperatures of 250 to 350° C. for 30 to 180 minutes. Further, without conducting the process of removing the solvent, the process of orientating the molecules of liquid crystalline polyester may be conducted. In this case, from the viewpoint of preventing the generation of voids owing to the rapid evaporation of the solvent within the film 2a, the temperature rising rate is preferable to be slow compared to the case of conducting the process of removing the solvent.

FIG. 3D is a schematic sectional view showing the process of peeling off adhesive layer 14 and carrier layer 12 from ultra thin copper foil 1. Substrate 10 can be manufactured like this.

As for substrate 10, the enough adhesive property of ultra thin copper foil 1 and liquid crystalline polyester layer 2 is assured. As the evaluation test on such adhesive property, there is a 180° peel strength test prescribed by JIS C6471 (1995), and 180° peel strength from resin layer 2 at 23° C. is preferable to be 7 N/cm or more, and more preferable to be 8 N/cm or more.

Moreover, substrate 10 has excellent folding endurance. As the evaluation test on such folding endurance, there is a folding endurance test prescribed by JIS C6471 (1995). And in the test in the condition that the radius of curvature of the folding surface is 0.38 mm and the tension is 4.9 N, it is preferable that the ultra thin copper foil does not break even if it is bent 100 times or more repeatedly.

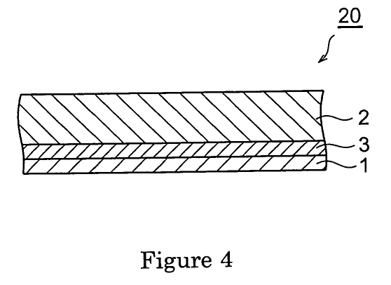

The substrate for flexible printed wiring of the present invention may be another embodiment as described below. FIG. 4 is a schematic fragmentary sectional view showing another embodiment related to the substrate for flexible printed wiring of the present invention. Substrate 20 shown in FIG. 4 has an intermediate layer 3 between ultra thin copper foil 1 and liquid crystalline polyester layer 2. In the substrate for flexible printed wiring of the present invention, if liquid crystalline polyester layer 2 is formed on ultra thin copper foil 1, the ultra thin copper foil 1 and the liquid crystalline polyester layer 2 may be not necessarily directly adjacent. Further, as intermediate layer 3, one layer or two or more layers of the rust prevention layer and the primer layer may be provided. Each of these intermediate layers 3 can be formed by the conventionally known methods.

Because the substrate for flexible printed wiring of the present invention have not only high folding endurance and high heat resistance but have an excellent characteristic of low water absorbing property, the applications of the substrate are not limited only to flexible printed wiring, the substrate is suitably used for multiplayer printed boards, film for tape automated bonding, and the like for the semiconductor package and the mother board, which are obtained by the buildup method and the like being paid attention in recent years.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2005-292479 filed on Oct. 5, 2005, including specification, claims, drawings and summary, are incorporated herein by reference in their entirety.

### EXAMPLES

The present invention is described in more detail by following Examples, which should not be construed as a limitation upon the scope of the present invention.

### Producing Example 1

<Synthesis of Liquid Crystalline Polyester A>

In a reactor equipped with a stirring device, a torque meter, a nitrogen gas introduction tube, a thermometer, and a reflux condenser, 941 g (5.0 mol) of 2-hydroxy-6-naphthoic acid, 273 g (2.5 mol) of 4-aminophenol, 415.3 g (2.5 mol) of isophthalic acid, and 1123 g (11 mol) of acetic anhydride were put in. After the reactor inside was substituted enough with nitrogen gas, the temperature within the reactor was raised to 150° C. in 15 minutes under the flow of nitrogen gas, and the liquid within the reactor was refluxed for three hours while the temperature was maintained.

After that, the temperature was raised to 320° C. in 170 minutes while distilled by-product acetic acid and unreacted acetic anhydride were removed, and when the rise of the torque was admitted, the reaction was considered to be ended and the content was taken out. After the obtained resin was crushed with a coarse crusher, the temperature was raised at the rate of 10° C./minute while a part of the powder was observed with a polarizing microscope, resulting in showing the schlieren pattern at 200° C. that is peculiar to the liquid crystallineline phase. The resin thus obtained is considered to be liquid crystalline polyester A.

### Producing Example 2

<Synthesis of Liquid Crystalline Polyester B>

In a reactor equipped with a stirring device, a torque meter, a nitrogen gas introduction tube, a thermometer, and a reflux condenser, 658.6 g (3.5 mol) of 2-hydroxy-6-naphthoic acid, 354.7 g (3.25 mol) of 4-hydroxyacetanilide, 539.9 g (3.25 mol) of isophthalic acid, and 1123.0 g (11 mol) of acetic anhydride were put in. After the reactor inside was substituted enough with nitrogen gas, the temperature within the reactor was raised to 150° C. in 15 minutes under the flow of nitrogen gas, and the liquid within the reactor was refluxed for three hours while the temperature was maintained.

After that, the temperature was raised to 300° C. in 170 minutes while distilled by-product acetic acid and unreacted acetic anhydride were removed, and when the rise of the torque was admitted, the reaction was considered to be ended and the content was taken out. Then, the obtained product was cooled to room temperature and crushed with a coarse crusher. After that, the crushed product was kept at 250° C. for 10 hours under the nitrogen atmosphere, and then cooled to room temperature and crushed again with the coarse crusher. After that, the product was kept at 240° C. for 3 hours under the nitrogen atmosphere, and the polymerization reaction was advanced in the solid phase and aromatic polyester powder was obtained. The resin thus obtained is considered to be liquid crystalline polyester B.

### Example 1

<The Manufacture of a Substrate for Flexible Printed Wiring>

After 8 g of powder of liquid crystalline polyester A obtained by Producing example 1 was added to 92 g of N-methyl-2-pyrrolidone (hereinafter, it is referred to as “NMP”), the mixture was heated to 160° C. and the liquid crystalline polyester was completely dissolved to give a brown transparent solution. This solution was stirred and defoamed and a liquid crystalline polyester solution was obtained. In this solution, aluminum borate (trade name: Alborex M20C, manufactured by Shikoku Chemicals Corporation, specific gravity is 3.0 g/cm³) was added as an inorganic filler. The amount of aluminum borate added was made to be 10 parts by volume to 100 parts by volume of liquid crystalline polyester. After the addition of aluminum borate, the mixture was dispersed and defoamed to give an applying liquid for a liquid crystalline polyester layer.

This applying liquid was applied on ultra thin copper foil with a carrier (trade name: Y-SNAP, manufactured by Nippon Denkai Ltd., the carrier layer thickness 18 μm/the ultra thin copper foil thickness 3 μm) with a film applicator and dried on a hot plate at 80° C. for one hour. After that, the copper foil was put in a hot-air oven and the temperature was raised from 30° C. to 300° C. at the rate of 5° C./minute under the nitrogen atmosphere and the copper foil was heat treated by being kept at 300° C. for one hour. And, after the copper foil was cooled to room temperature, the carrier layer was peeled off and a substrate for flexible printed wiring was obtained.

Evaluation of the Substrate:

In order to evaluate the characteristic of the substrate for flexible printed wiring thus obtained, the following evaluation test was carried out. The test method was followed the method prescribed by JIS C6471 (1995).

Measurement of 180° Peel Strength:

The 180° peel strength of the substrate for flexible printed wiring manufactured in Example 1 was measured with a tension tester as follows. That is, after depositing copper to provide a cupper layer with 12 μm on the surface of the copper foil side of the substrate for flexible printed wiring, a reinforcing plate was stuck together to the surface of the liquid crystalline polyester layer side of the substrate with a double-faced adhesive tape to reinforce so that ultra thin copper foil can be torn off from the liquid crystalline polyester layer surely to the direction of 180°. And a part of the ultra thin copper foil was torn off from the liquid crystalline polyester layer, and one end of the substrate for flexible printed wiring from which the ultra thin copper foil was torn off was fixed to the one clamp of the tension tester and the torn off ultra thin copper foil was fixed to the other clamp. From this state, the ultra thin copper foil was continuously torn off to the direction of 180° and the load during the meantime was measured. Further, the measurement was carried out while the room temperature was controlled to 23° C. The measurement results of 180° peel strength were shown in Table 1.

Folding Endurance Test:

The folding endurance of the substrate for flexible printed wiring manufactured in Example 1 was measured with a folding endurance tester. Provided that the radius of curvature of the folding surface is 0.38 mm and the folding angle is 135°, the substrate for flexible printed wiring was bent repeatedly at the speed of 175 times/minute at the tension of 4.9 N, and the number of times of folding was measured until the substrate for flexible printed wiring was broken. The results of the folding endurance test were shown in Table 1.

### Example 2

A substrate for flexible printed wiring was manufactured by the same method as that in Example 1, except that ultra thin copper foil with a carrier having the carrier layer thickness 35 μm/the ultra thin copper foil thickness 5 μm (trade name: XTF, manufactured by Nippon Olin Brass Corp.) was used in place of ultra thin copper foil with a carrier (the carrier layer thickness 18 μm/the ultra thin copper foil thickness 3 μm) used in Example 1. And both evaluation tests were also carried out in the same way. The evaluation results were shown in Table 1.

TABLE 1

| | Example 1 | Example 2 |
|---|---|---|
| | Liquid | Liquid |
| | crystalline | crystalline |
| The resin layer | polyester | polyester |
| The thickness of copper foil | 3 | 5 |
| (μm) | | |
| 180° peel strength (N/cm) | 8.3 | 8.2 |
| The results of the folding | 100 times or | 100 times or |
| endurance tests | more | more |
| (The number of times) | | |

### Example 3

A substrate for flexible printed wiring is obtained in the same manner as in Example 1 except that the inorganic filler is not utilized. The resulting substrate for flexible printed wiring has almost the same 180° peel strength and folding endurance property as those of the substrate obtained in Example 1.

### Comparative Example 1

A liquid crystalline polyester layer was formed by the same method as that in Example 1, except that copper foil of 9 μm in thickness, which is not fixed on the carrier layer, (trade name: SQ-VLP, manufactured by Mitsui Mining And Smelting Company, Limited) was used in place of ultra thin copper foil with a carrier (the carrier layer thickness 18 μm/the ultra thin copper foil thickness 3 μm) used in Example 1. However, in Comparative example 1, creases generated in the copper foil during the heat treatment process, so no substrate that can be used-as a flexible printed wiring could be obtained.

### Reference Example 1

<Manufacture of a Liquid Crystalline Polyester Film>

An applying liquid for a liquid crystalline polyester layer was obtained by the same method as that in the above-mentioned Example 1. The applying liquid was applied on copper foil (18 μm in thickness) by casting and dried on a hot plate at 80° C. for one hour. After that, the applied copper foil was heat treated at 300° C. for one hour in a hot-air oven under the nitrogen atmosphere to make a film on the copper foil. After being cooled to room temperature, the copper foil was etched by dipping in aqueous iron (III) chloride solution (Baume degree is 40°, produced by Kida Co., Ltd.) and a liquid crystalline polyester film was obtained.

<Manufacture of a Polyimide Film>

Based on a literature (Polymer, 1998, vol. 39, pp. 2963-2972), polyamic acid was synthesized as follows. That is, after the inside of a 100 ml four-neck flask equipped with a nitrogen gas introduction tube, a thermometer, and a stir rod was substituted with nitrogen gas, 4.45 g (22.2 mmol) of 4,4′-diaminodiphenyl ether was put in the flask, and then 106.84 g of NMP was added to dissolve the 4,4′-diaminodiphenyl ether completely. Further, 4.84 g (22.2 mmol) of pyromellitic dianhydride was added and stirred at the reaction temperature of 25° C. for 15 hours to give a brown viscous polyamic acid solution. The polyamic acid solution thus obtained was applied on copper foil (thickness: 18 μm) with a film applicator and dried by heating at 80° C. for one hour, and then heated again at 350° C. for one hour. After being cooled to room temperature, the copper foil was etched by dipping in aqueous iron (III) chloride solution (Baume degree is 40°, produced by Kida Co., Ltd.) and a polyimide film was obtained.

The characteristics of the liquid crystalline polyester film and the polyimide film manufactured by the above-mentioned methods were evaluated. In Table 3, measured values on dielectric constant and dielectric dissipation factor at 1 GHz and the temperature of 23° C., besides water absorption coefficient (after being left for 24 hours in the conditions that temperature is 23° C. and humidity is 50%) were shown.

TABLE 3

| | | | Water |
|---|---|---|---|
| | | Dielectric | absorption |
| | Dielectric | dissipation | coefficient |
| Resin materials | constant | factor | (%) |
| Liquid crystalline | 3.4 | 0.0029 | 0.04 |
| polyester A | | | |
| Liquid crystalline | 3.3 | 0.0034 | 0.08 |
| polyester B | | | |
| Polyimide | 3.5 | 0.006 | 1.5 |

1. A substrate for flexible wiring comprises a liquid crystalline polyester layer and a copper foil with a thickness of 5 μm or less.

2. The substrate according to claim 1, wherein the substrate has 7 N/cm or more of peel strength at an angle of 180° between the resin layer and the copper foil is at 23° C.

3. The substrate according to claim 1, wherein the resin layer is formed by applying a solution containing a liquid crystalline polyester and a solvent on a copper foil with a thickness of 5 μm or less, and removing the solvent.

4. The substrate according to claim 1, wherein the resin layer contains an inorganic filler.

5. The substrate according to claim 1, wherein the substrate has folding endurance of 100 or more of times in repeating, folding test.

6. The substrate according to claim 1, wherein the liquid crystalline polyester has structural units represented by formulas (i), (ii) and (iii) below, and the amounts of the structural units represented by the formula (i), (ii) and (iii) are 30 to 80% by mole, 10 to 35% by mole and 10 to 35% by mole on the basis of the total structural units in the polyester, respectively;
—O—Ar¹—CO— (i)
—CO—Ar²—CO— (ii)
—X—Ar³—Y— (iii)
where Ar¹ indicates phenylene, naphtylene or biphenylene, Ar² indicates that phenylene, naphthylene, biphenylene, oxybiphenylene or a bivalent condensed aromatic ring, Ar³ indicates phenylene or a bivalent condensed aromatic ring, X and Y are the same or different, each independently indicating —O— or —NH—; and the hydrogen atom(s) bonded the aromatic ring of Ar¹, Ar² and Ar³ may be substituted by a halogen atom, an alkyl group or an aryl group.

7. The substrate according to claim 1, wherein the liquid crystalline polyester has the structural unit derived from aromatic diamine and/or the structural unit derived from aromatic amine having a hydroxyl group in the amount of 10 to 35% by mole on the basis of the total structural units.

8. A method for producing a substrate for flexible printed wiring, the method comprising the steps of applying a solution containing a liquid crystalline polyester and a solvent on a copper foil with a thickness of 5 μm or less in which the copper foil is placed on a support, removing the solvent and removing the support from the copper foil.

9. The method for producing a substrate according to claim 8, the method further comprising the step of orientating the molecules of the liquid crystalline polyester by heating before or after the removing of the solvent.

10. The method for producing a substrate according to claim 8, wherein the support comprises a metal.

11. The method for producing a substrate according to claim 8, wherein the copper foil is fixed on the support through a thermal diffusion prevention layer.
